(19) United States
(12) Patent Application Publication
(10) Pub. No.: US 2005/0044735 A1
(43) Pub. Date: Mar. 3, 2005

(54) Laser leveling device having selectable light beam

(76) Inventor: Vincent Liao, Taichung (TW)

Correspondence Address: Vincent Liao, P.O. Box 63-99, Taichung, 406, TW

(21) Appl. No.: 10/652,462

(22) Filed: Aug. 29, 2003

(51) Int. Cl. G01C 15/00

(52) U.S. Cl. 33/286

(57) ABSTRACT

A laser leveling device includes a laser instrument disposed in a housing, a plate slidably received in the housing and a lens attached to the plate. The plate is movable relative to the housing to selectively align the lens with the laser instrument, to allow the light beam generated by the light emitting device to selectively emit through the lens. The plate includes an aperture movable to align with the laser instrument, to allow the light beam to selectively emit through the aperture of the plate directly, without emitting through the lens. A switch may be actuated by the plate to actuate the laser instrument when either the aperture of the plate or the lens is aligned with the laser instrument.

### BACKGROUND OF THE INVENTION

1. Field of the Invention

The present invention relates to a laser leveling device, and more particularly to a laser leveling device having selectable light beams.

2. Description of the Prior Art

Various kinds of typical laser leveling devices have been developed and comprise a laser instrument for generating a light beam.

For example, U.S. Pat. No. 5,118,184 to Kordana discloses one of the typical laser leveling devices which comprises two laser instruments or two transit units for generating light beams toward different directions. However, the light beams generated by the laser instruments are predetermined and may not be changed to the other light beams.

U.S. Pat. No. 5,539,990 to Le discloses the other typical laser leveling device which comprises a laser instrument for generating light beams through one or two lenses to generate different light beams.

However, the lenses of the conventional or typical laser leveling devices are solidly disposed or secured in the predetermined position of the laser instrument, and may not be moved or adjusted relative to the laser instrument to different positions.

The present invention has arisen to mitigate and/or obviate the afore-described disadvantages of the conventional laser leveling devices.

### SUMMARY OF THE INVENTION

The primary objective of the present invention is to provide a laser leveling device having a slidable plate to selectively change to different light beams.

In accordance with one aspect of the invention, there is provided a laser leveling device comprising a housing, a laser instrument disposed in the housing for generating a light beam, a plate slidably received in the housing, and a lens attached to the plate. The plate is movable relative to the housing to selectively align the lens with the laser instrument, to allow the light beam generated by the light emitting device to selectively emit through the lens.

The housing includes a switch disposed therein, the plate includes an actuator extended therefrom to selectively engage with the switch, and to selectively actuate the laser instrument when the lens is aligned with the laser instrument. The switch includes a knob provided thereon for being actuated by the actuator of the plate. The plate includes a handgrip provided thereon for moving the plate relative to the housing.

The plate includes an aperture formed therein, and movable to be selectively aligned with the laser instrument when the plate is moved relative to the housing, to allow the light beam generated by the light emitting device to selectively emit through the aperture of the plate directly, without emitting through the lens. The plate includes another actuator extended therefrom to selectively engage with the switch, and to selectively actuate the laser instrument when the aperture of the plate is aligned with the laser instrument.

One or more batteries may be disposed in the housing and coupled to the laser instrument for energizing the laser instrument. The housing further includes at least one bubble leveling vial attached thereon. The housing includes a magnetic member disposed therein for attracting and securing the housing onto a supporting member. The housing includes a rotary member having a nail extended therefrom and selectively extendible out of the housing for engaging into a supporting member.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a perspective view of a laser leveling device in accordance with the present invention;

FIGS. 2, 3 are perspective views similar to FIG. 1, illustrating the operation of the laser leveling device; and

FIGS. 4, 5, 6 are cross sectional views of the laser leveling device, taken along lines 4-4, 5-5, and 6-6 of FIGS. 1-3 respectively.

### DETAILED DESCRIPTION OF THE PREFERRED EMBODIMENT

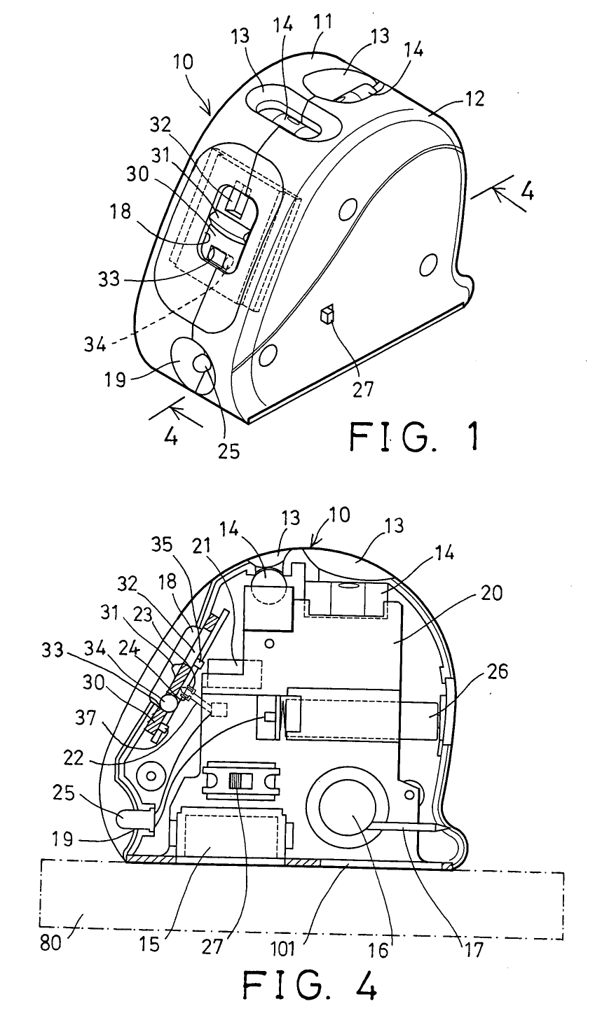

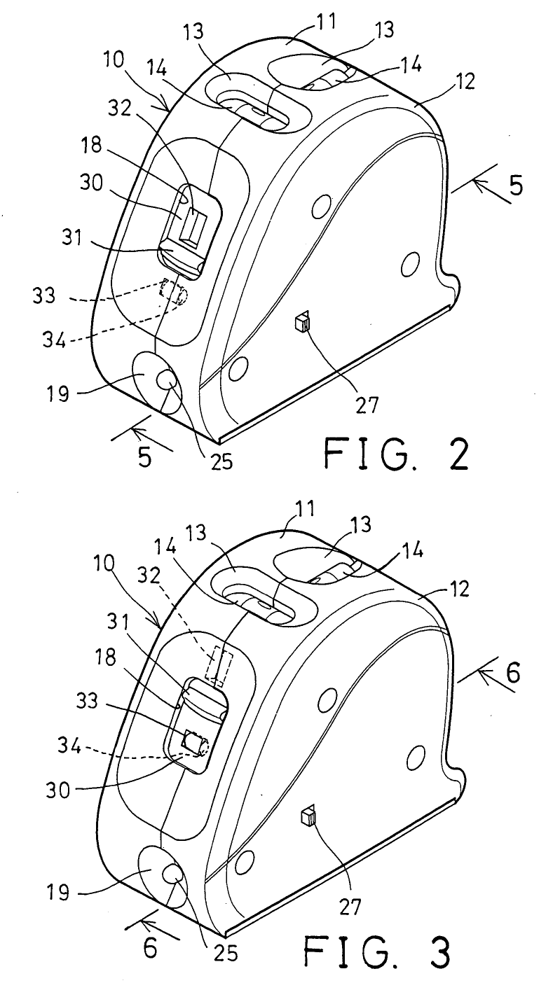

Referring to the drawings, and initially to FIGS. 1-4, a laser leveling device in accordance with the present invention comprises a housing 10 including two housing members 11, 12 secured together with fasteners (not shown), adhesive materials, or by welding processes. The housing 10 includes one or more depressions 13 formed therein to receive bubble leveling vials 14 therein respectively.

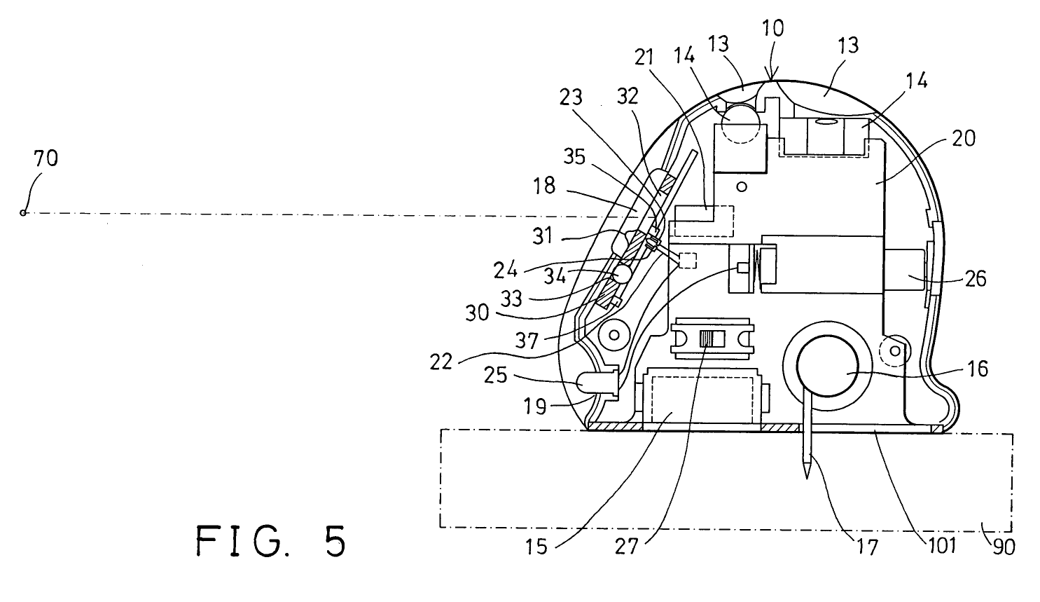

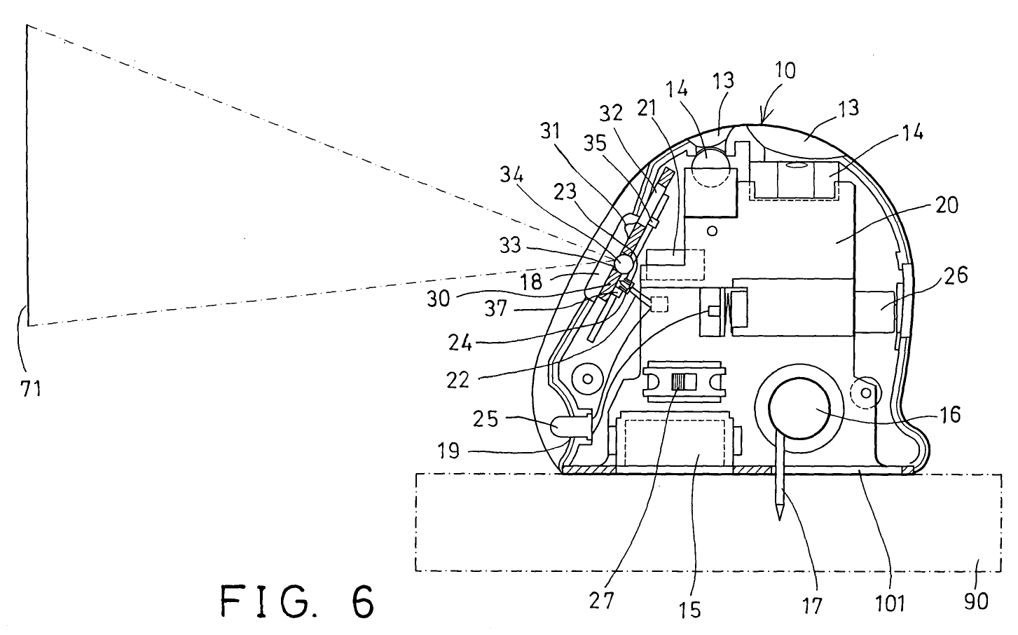

The housing 10 includes a magnetic member 15, such as an electromagnetic member 15 disposed in the bottom portion thereof for stably attracting and securing the housing 10 onto a metal or an electromagnetic supporting member 80 (FIG. 4). The housing 10 further includes a rotary member 16 rotatably received in the bottom portion thereof, and includes a nail 17 attached thereto and rotatable outwardly through a groove 101 of the housing 10 (FIGS. 5, 6), for engaging into a wood or other supporting member 90.

The housing 10 includes an opening 18 formed in the front and middle portion thereof, and includes an orifice 19 formed in the front and lower portion thereof. A circuit board 20 is received and secured in the housing 10, and includes a laser instrument 21 attached thereto or received and secured in the housing 10. The laser instrument 21 is aligned with or directed toward the opening 18 of the housing 10, for generating and emitting various light beams 70, 71 out through the opening 18 of the housing 10 (FIGS. 5, 6).

A switch 22 is attached to the circuit board 20 and/or received and secured in the housing 10, and includes two triggers or knobs 23, 24 to be depressed or actuated to control the switch 22. An indicating light member 25 is engaged in the orifice 19 of the housing 10, and coupled to the circuit board 20, and one or more batteries 26 are attached to the circuit board 20 or to the housing 10, and are electrically coupled to energize the laser instrument 30 and/or the indicating light member 25, and/or the other electric elements, such as the electromagnetic member 15.

Another switch 27 may further be provided and attached to the circuit board 20 and/or secured to the housing 10, and coupled to the circuit board 20 and/or to the laser instrument 30 and/or the indicating light member 25, and/or the other electric elements, such as the electromagnetic member 15, in order to control the operation of the electric elements 15, 21, 25.

A plate 30 is slidably received in the housing 10, and arranged behind the opening 18 of the housing 10, and includes a hand grip 31 provided thereon or extended therefrom for moving the plate 30 relative to the housing 10, or for moving the plate 30 along the opening 18 of the housing 10. The plate 30 includes an aperture 32 formed therein and to be selectively aligned with the laser instrument 21, for allowing the light beam 70 generated by the laser instrument 21 to emit through the aperture 32 of the plate 30, and thus through the opening 18 of the housing 10 (FIG. 5).

The plate 30 further includes a recess 33 formed therein (FIG. 2), and a lens 34 received or engaged in the recess 33 of the plate 30, and to be selectively aligned with the laser instrument 21, for allowing the light beam 71 generated by the laser instrument 21 to emit through the lens 34, and thus through the opening 18 of the housing 10 (FIG. 6). The aperture 32 of the plate 30 and the lens 34 may be selectively moved to align with the laser instrument 21 when the plate 30 is moved relative to the housing 10 with the hand grip 31, for example.

The plate 30 includes a first actuator 35 extended therefrom, for engaging with or for depressing the knob 23 of the switch 22, in order to control or to actuate or to energize the laser instrument 21, when the aperture 32 of the plate 30 is moved to align with the laser instrument 21, and thus for allowing the light beam 70 generated by the laser instrument 21 to emit through the aperture 32 of the plate 30, and thus through the opening 18 of the housing 10 (FIG. 5).

The plate 30 further includes a second actuator 37 extended therefrom, for engaging with or for depressing the other knob 24 of the switch 22, in order to control or to actuate or to energize the laser instrument 21, when the recess 33 of the plate 30 and the lens 34 are moved to align with the laser instrument 21, and thus for allowing the light beam 71 generated by the laser instrument 21 to emit through the lens 34, and thus through the opening 18 of the housing 10 (FIG. 6).

As shown in FIGS. 1 and 4, when neither the aperture 32 of the plate 30 nor the recess 33 of the plate 30 and the lens 34 are aligned with the laser instrument 21, neither of the knobs 23, 24 of the switch 22 will not be actuated or depressed by the actuators 35, 37, such that the switch 22 will not be actuated, and such that the laser instrument 21 will not be energized to generate the light beams 70, 71.

As shown in FIG. 5, when the aperture 32 of the plate 30 is moved to align with the laser instrument 21, the light beam 70 generated by the laser instrument 21 is not blocked by the plate 30 and may be emitted through the aperture 32 of the plate 30 and the opening 18 of the housing 10, such that the shape of the light beam 70 will not be changed, and the light beam 70 may include various shape, such as a point or dot shape, a line shape, a cross shape, or the like.

As shown in FIG. 6, when the recess 33 of the plate 30 and the lens 34 are moved to align with the laser instrument 21, the light beam 71 generated by the laser instrument 21 may emit through the lens 34 and the opening 18 of the housing 10, such that the shape of the light beam 71 will be changed via the lens 34. For example, the light beam may be changed from a point or dot shape to a line shape or the like.

Accordingly, the laser leveling device in accordance with the present invention may be used to switch to or to select different light beams.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

1. A laser leveling device comprising:
a housing including a switch disposed therein,
a laser instrument disposed in said housing for generating a light beam,
a plate slidably received in said housing, and including an aperture formed therein, and movable to be selectively aligned with said laser instrument when said plate is moved relative to said housing, to allow the light beam generated by said laser instrument to selectively emit through said aperture of said plate directly and said plate including an actuator extended therefrom to selectively engage with said switch, and to selectively actuate said laser instrument when said plate is moved relative to said housing, and
a lens attached to said plate,
said plate being movable relative to said housing to selectively align said lens with said laser instrument, to allow the light beam generated by said laser instrument to selectively emit through said lens, without emitting through said aperture of said plate.

2. The laser leveling device as claimed in claim 1, wherein said actuator of said plate is selectively engageable with said switch, and to selectively actuate said laser instrument when said lens is aligned with said laser instrument.

3. The laser leveling device as claimed in claim 2, wherein said switch includes a knob provided thereon for being actuated by said actuator of said plate.

4. The laser leveling device as claimed in claim 1, wherein said plate includes a hand grip provided thereon for moving said plate relative to said housing.

5. (cancelled).

6. The laser leveling device as claimed in claim 1, wherein said actuator of said plate is selectively engageable with said switch, and to selectively actuate said laser instrument when said aperture of said plate is aligned with said laser instrument.

7. (cancelled).

8. The laser leveling device as claimed in claim 1 further comprising means for energizing said laser instrument.

9. The laser leveling device as claimed in claim 1, wherein said housing further includes at least one bubble leveling vial attached thereon.

10. The laser leveling device as claimed in claim 1, wherein said housing includes a magnetic member disposed therein for attracting and securing said housing onto a supporting member.

11. The laser leveling device as claimed in claim 1, wherein said housing includes a rotary member having a nail extended therefrom and selectively extendible out of said housing for engaging into a supporting member.
